(19) United States
(12) Patent Application Publication
(10) Pub. No.: US 2024/0373240 A1
(43) Pub. Date: Nov. 7, 2024

(54) RADIO COMMUNICATION NODE, BASE STATION, AND RADIO COMMUNICATION METHOD

(71) Applicant: NTT DOCOMO, INC., Tokyo (JP)

(72) Inventors: Daisuke Kurita, Tokyo (JP); Hiroki Harada, Tokyo (JP); Weiqi Sun, Beijing (CN); Jing Wang, Beijing (CN); Lan Chen, Beijing (CN)

(73) Assignee: NTT DOCOMO, INC., Tokyo (JP)

(21) Appl. No.: 18/284,424

(22) PCT Filed: Mar. 31, 2021
(86) PCT No.: PCT/JP2021/014095

§ 371 Date: Sep. 27, 2023

(51) Int. Cl. H04W 16/14; H04L 27/26; H04W 8/22; H04W 88/08

(52) U.S. Cl. CPC H04W 16/14; H04L 27/2605; H04W 8/22; H04W 88/08

(57) ABSTRACT

A radio communication node (100B) performs connection for a parent node and for a lower node that are capable of sharing a radio resource in frequency division multiplexing. The radio communication node (100B) controls a guard band relating to the radio resource for the parent node and for the lower node.

### TECHNICAL FIELD

This disclosure relates to a radio communication node, a base station, and a radio communication method that configure radio access and radio backhaul.

### BACKGROUND ART

The 3rd Generation Partnership Project (3GPP) has specified the 5th generation mobile communication system (also known as 5G, New Radio (NR), or Next Generation (NG)), and is also preparing a next generation specification called Beyond 5G, 5G Evolution, or 6G.

For example, in a radio access network (RAN) with NR, integrated access and backhaul (IAB) has been considered which integrates radio access to terminals (user equipment, UE) and radio backhaul between radio communication nodes such as radio base stations (gNBs).

In IAB, an IAB node has a mobile termination (MT), which is a function for connection to a higher node such as a parent node or an IAB donor central unit (CU), and a distributed unit (DU), which is a function for connection to a lower node such as a child node or a UE.

In Release 16 of 3GPP, half-duplex and time-division multiplexing (TDM) are assumed in radio access and radio backhaul. In Release 17, simultaneous operation of an MT and DU (simultaneous Tx/Rx) has been considered, and frequency division multiplexing (FDM), space-division multiplexing (SDM), and full-duplex communication have been considered (Non-Patent Literature 1).

In particular, regarding frequency division multiplexing (FDM), it has been considered whether to support the extension of a semi-static DU resource type indication for a frequency-domain resource within a carrier, in resource types of H/[S]/NA (hard/soft/not available) (Non-Patent Literature 2).

### CITATION LIST

### Non-Patent Literature

Non-Patent Literature 1: 3GPP Release 17, Dec. 12, 2020, 3GPP <URL: https://www.3gpp.org/release-17> Non-Patent Literature 2: 3GPP RAN1 #104-e, January to February 2021, 3GPP <URL: https://www.3gpp.org/ftp/tsg_ran/WG1_RL1/TSGR1_104-e/>

### SUMMARY OF THE INVENTION

Here, when FDM is performed between an MT and DU, in order to avoid interference between MT transmission/reception (Tx/Rx) and DU transmission/reception (Tx/Rx), it is conceivable to configure a frequency use prohibited range (what is referred to as a guard band) indicating a frequency band that should be prohibited from use.

However, it is necessary to appropriately configure how the pattern in a guard band is determined, for example, whether a DU NA resource is used as a guard band or not at the boundary between a DU hard resource and a DU NA resource.

Therefore, the following disclosure has been made in view of these circumstances, and an object of the present disclosure is to provide a radio communication node and a radio communication method that is capable of preventing interference by appropriately managing frequency resources when performing frequency division multiplexing (FDM) in an MT and DU in integrated access and backhaul (IAB).

An aspect of the present disclosure is a radio communication node (radio communication node 100B) including: a connection unit (higher node connection unit 170, lower node connection unit 180) that is used for connection for a parent node (parent node 100A) and for a lower node (child node 100C) that are capable of sharing a radio resource in frequency division multiplexing; and a control unit (control unit 190) that controls a guard band relating to the radio resource for the parent node (parent node 100A) and for the lower node (child node 100C).

In addition, an aspect of the present disclosure is a base station (radio communication node 100B) including: a connection unit (higher node connection unit 170, lower node connection unit 180) that is used for connection for a parent node (parent node 100A) and for a lower node (child node 100C) that are capable of sharing a radio resource in frequency division multiplexing; and a control unit (control unit 190) that controls a guard band relating to the radio resource for the parent node (parent node 100A) and for the lower node (child node 100C).

In addition, an aspect of the present disclosure is a radio communication method including: a step of performing connection for a parent node (parent node 100A) and for a lower node (child node 100C) that are capable of sharing a radio resource in frequency division multiplexing; and a step of controlling a guard band relating to the radio resource for the parent node (parent node 100A) and for the lower node (child node 100C).

### BRIEF DESCRIPTION OF THE DRAWINGS

FIG. 1 is an overall schematic diagram of a radio communication system 10.

FIG. 2 is a diagram illustrating an example of a basic configuration of IAB.

FIG. 3A is a diagram illustrating types and control examples for DU resources in FDM.

FIG. 3B is a diagram illustrating types and control examples for DU resources in FDM.

FIG. 4 is a configuration diagram illustrating a functional block of a parent node 100A.

FIG. 5 is a configuration diagram illustrating a functional block of an IAB node 100B constituting an IAB node.

FIG. 6 is a diagram illustrating an example of Case 1 (a guard band at a boundary between H/NA frequency resources in adjacent DUs).

FIG. 7 is a diagram illustrating an example of Case 2 (a guard band at a boundary between hard/soft INA resources).

FIG. 8 is a diagram illustrating an example of Case 3 (a guard band at a boundary between soft IA/NA resources).

FIG. 9 is a diagram illustrating an example of Case 4 (a guard band at a boundary between soft-IA/soft-INA resources).

FIG. 10 is a diagram illustrating another embodiment of Cases 1, 2, 3, and 4 (modified example).

FIG. 11 is a diagram illustrating Operation Example 2 in which a guard band is explicitly configured.

FIG. 12 is a diagram illustrating an example of a hardware configuration of a CU 50, radio communication nodes 100A to 100C, and a UE 200.

### DESCRIPTION OF EMBODIMENTS

Embodiments will be described below with reference to the drawings. The same or similar elements illustrated in the drawings are denoted by the same or similar reference numerals, and the descriptions thereof will be omitted as appropriate.

### (1) Overall Schematic Configuration of Radio Communication System

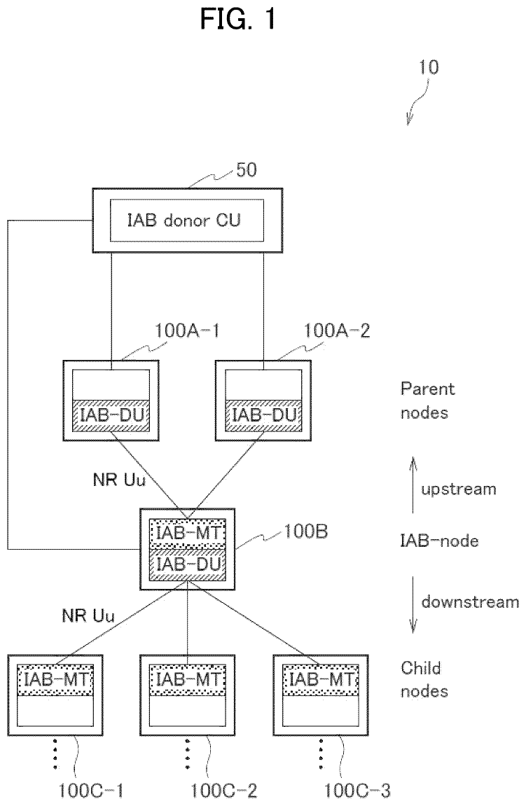

FIG. 1 is an overall schematic diagram of a radio communication system 10 according to the present embodiment. The radio communication system 10 is a radio communication system in accordance with 5G New Radio (NR) or 6G, and is configured of multiple radio communication nodes and a terminal.

Specifically, the radio communication system 10 includes a central unit 50 (hereafter, CU 50), radio communication nodes (including parent nodes 100A, an IAB node 100B and lower nodes 100C), and a user terminal 200 (hereafter, UE 200).

The radio communication nodes 100A, 100B, and 100C can configure radio access with the UE 200, and radio backhaul (BH) between the radio communication nodes. Specifically, backhauls (transmission paths) using radio links are configured between the parent nodes 100A and the IAB node 100B, and between the IAB node 100B and the lower nodes 100C.

A configuration in which radio access to the UE 200 and radio backhaul between the radio communication nodes are integrated is called integrated access and backhaul (IAB).

IAB reuses existing functions and interfaces defined for radio access. In particular, mobile termination (MT), a gNB-DU (distributed unit), a gNB-CU (central unit), a user plane function (UPF), an access and mobility management function (AMF), a session management function (SMF), and corresponding interfaces such as NR Uu (between MT and gNB/DU), F1, NG, X2, and N4 are used as a baseline.

The parent nodes 100A are connected to a radio access network with NR (NG-RAN) and a core network (Next Generation Core (NGC) or 5GC) via a wired transmission path such as fiber transport. The NG-RAN/NGC includes a central unit 50 (CU 50), which is a communication node. The NG-RAN and NGC may simply be described as a “network”. The number of parent nodes 100A is not limited to the example illustrated in FIG. 1. The parent nodes 100A-1 and 2 can be classified into a master cell group (MCG) which is a group of cells formed by a master radio base station, and a secondary cell group (SCG) which is a group of cells formed by a secondary radio base station.

The IAB node 100B is connected to a 5G (NR) or a 6G radio access network (NG-RAN) and to a core network (NGC or 5GC) via a wired transmission path such as a fiber transport. The NG-RAN/NGC includes the CU 50, which is a communication node.

The CU 50 may be configured of any of the UPF, AMF and SMF described above or a combination thereof. Alternatively, the CU 50 may be a gNB-CU as described above. Also, in IAB, the CU 50 may be specifically referred to as an IAB donor CU.

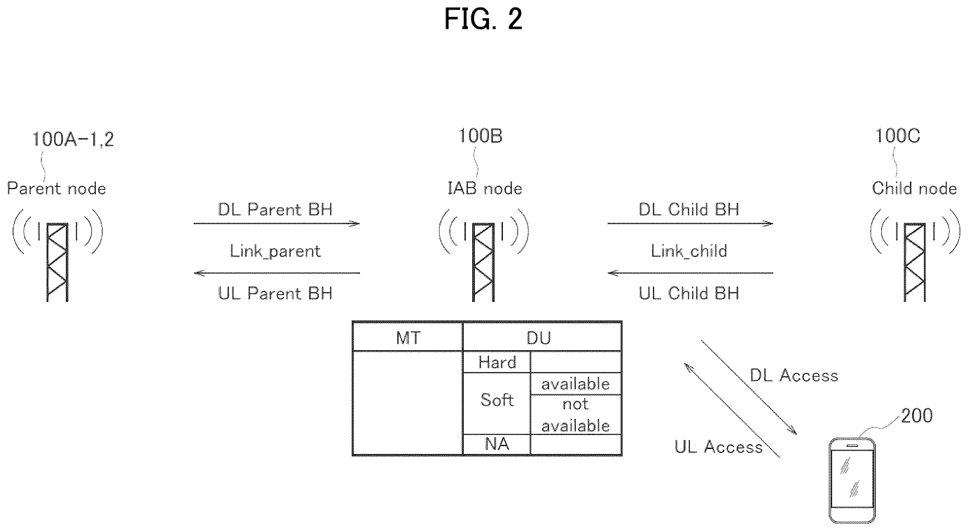

FIG. 2 is a diagram illustrating an example of a basic configuration of IAB. As illustrated in FIG. 2, in the present embodiment, the radio communication node 100A constitutes a parent node in IAB, the radio communication node 100B constitutes an IAB node in IAB, and the radio communication node 100C constitutes a child node in IAB. In the present embodiment, the child node 100C is illustrated as a separate housing from the UE 200; however, a lower node may include the UE 200 in addition to a child node. For this reason, in the present embodiment, the child node 100C may be read as meaning the UE 200.

The parent node may be referred to as a higher node in relation to the IAB node. Accordingly, in the present embodiment, the parent node may be read as meaning the higher node, and the higher node may be read as meaning the parent node. The higher node may include the IAB donor CU 50 in addition to the parent node 100A. Further, the IAB node 100B may be referred to as a child node or a lower node in relation to the parent node 100A.

As described above, as a child node or as a lower node in IAB, the UE 200 may be a child node. Accordingly, in the present embodiment, a child node may be read as meaning a lower node, or a lower node may be read as meaning a child node. The IAB node 100B may be referred to as a parent node or a higher node in relation to the child node 100C, and the child node 100C may be referred to as a child node or a lower node in relation to the IAB node 100B.

A radio link is configured between the parent node and the IAB node. Specifically, a radio link called Link parent is configured.

A radio link is configured between the IAB node and the child node. Specifically, a radio link called Link child is configured.

A radio link that is configured between such radio communication nodes is called a radio backhaul link. The Link parent includes a DL Parent BH in the downlink direction and a UL Parent BH in the uplink direction. The Link child includes a DL Child BH in the downlink direction and a UL Child BH in the uplink direction.

A radio link that is configured between the UE 200 and the IAB node or the parent node is called a radio access link. Specifically, the radio access link includes DL Access in the downlink direction and UL Access in the uplink direction.

Since the radio backhaul link and the radio access link can share a radio resource due to half-duplex communication or simultaneous communication or the like, resource division techniques such as time division multiplexing (TDM), frequency division multiplexing (FDM), and space division multiplexing (SDM) are required. In the present embodiment, a description will be given, in particular, regarding a case in which frequency division multiplexing (FDM) is performed.

The IAB node has a mobile termination (MT), which is a function for connection to a higher node such as a parent node, and a distributed unit (DU), which is a function for connection to a lower node such as a child node or the UE 200. Although not illustrated in FIG. 2, the parent node and the child node also have an MT and DU (see FIG. 1).

The radio resource used by the DU includes, from the viewpoint of the DU, a downlink (DL), an uplink (UL) and a flexible resource (D/U/F), and the radio resource is classified into any type of hard, soft, or not available (H/S/NA). In addition, “available” or “not available” (NA) is also specified in soft(S).

A flexible resource (F) is a resource that is available to any one of a DL or UL.

In addition, “hard” indicates that the corresponding radio resource is always available for a DU child link of DU that is connected to a lower node such as a child node or a UE. That is, the radio resource is designated exclusively for a lower node. In contrast, “soft” indicates that the availability of the corresponding radio resource for a DU child link is explicitly or implicitly controlled by a higher node such as a parent node or a CU. That is, the radio resource is not designated exclusively for a lower node. Note that a radio resource for a lower node which is configured as soft is referred to as a DU soft resource in some cases.

Therefore, any one of DL-H, DL-S, UL-H, UL-S, F-H, F-S, or NA is configured as a DU resource.

Although the configuration example of IAB illustrated in FIG. 2 assumes CU/DU division, IAB is not necessarily limited to such a configuration. For example, in radio backhaul, IAB may be configured by tunneling using the GPRS Tunneling Protocol (GTP)-U/User Datagram Protocol (UDP)/Internet Protocol (IP).

The main advantage of IAB is that NR cells can be arranged flexibly and densely without increasing the density of the transport network. IAB can be applied to a variety of scenarios, including outdoor small cell arrangement, indoor, and even support for mobile relay (for example, in buses and on trains).

Further, IAB may support deployment by means of NR-only standalone (SA), or deployment by means of non-standalone (NSA) including other RATs (such as LTEs), as illustrated in FIGS. 1 and 2.

In the present embodiment, radio access and radio backhaul may be either half-duplex communication, or may be full-duplex communication such as simultaneous communication (Tx and/or Rx) in an MT and DU.

In addition, time division multiplexing (TDM), space division multiplexing (SDM), and frequency division multiplexing (FDM) are available as multiplexing schemes. In the present embodiment, frequency division multiplexing (FDM) is in particular performed.

When the IAB node 100B operates in half-duplex communication, the DL Parent BH is on the receiving (RX) side, the UL Parent BH is on the transmitting (TX) side, the DL Child BH is on the transmitting (TX) side, and the UL Child BH is on the receiving (RX) side. In time division duplex (TDD), the configuration pattern of DL/UL in the IAB node is not limited to only DL-F-UL. For example, other configuration patterns, such as only radio backhaul (BH) or UL-F-DL, may be applied.

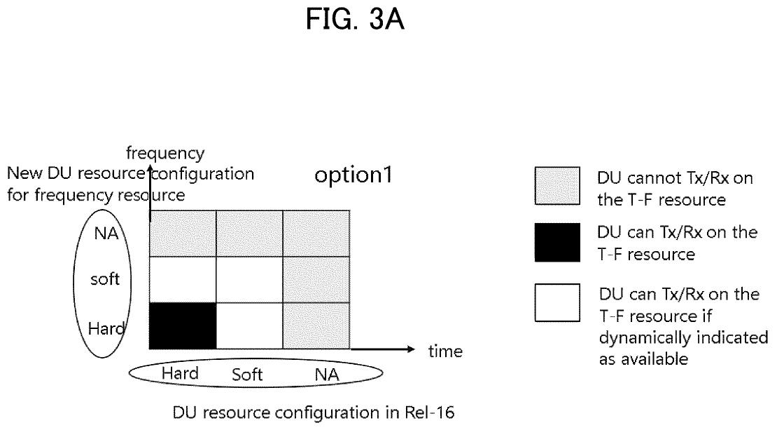

In some cases, the present embodiment focuses on the fact that FDM is used in a backhaul link and an access link to realize simultaneous operation of a DU and MT in the IAB node, but the present embodiment is not limited to this configuration. For example, TDM/SDM may be used in a backhaul link and an access link. FIG. 3 includes diagrams illustrating types and control examples for DU resources in FDM. The gray part of the diagram indicates that the DU is not able to use a resource for transmission and reception, the black part indicates that the DU is able to use a resource for transmission and reception, and the white part indicates that the DU is able to use a resource if the resource is dynamically indicated as available.

As illustrated in FIG. 3A, in option 1, each DU serving cell can configure a hard, soft, and NA type for each frequency resource (in addition to the configuration of a resource type for a time resource in Release 16). As illustrated therein, whether the DU can use the time-frequency (T-F) resource is determined by both the H/S/NA configuration of a DU symbol in Release-16, and the H/S/NA configuration of the frequency resource in this option 1.

Further, as illustrated in FIG. 3B, in option 2, each DU serving cell can configure each time-frequency (T-F) resource as a hard, soft, and NA type. In this option 2, no DU resource configuration is required for H/S/NA of a DU symbol in Release-16. Whether the DU can use a time-frequency resource is determined directly by the configuration of this option 2.

This configuration may be provided from the CU to the IAB node via F1-AP or RRC signaling. As an example of IAB node operations with H/S/NA resources, “hard” may mean that the DU can perform transmission/reception (Tx/Rx) with respect to the resource, “soft” may mean that the DU can perform transmission/reception (Tx/Rx) with respect to the resource when the resource is dynamically indicated as being explicitly or implicitly available, and “NA” may mean that the DU cannot perform transmission/reception (Tx/Rx) with respect to the resource. Note that in option 1, when the time units are different, different types of H/S/NA resources may be configured for frequency resources. Here, as an example, a time unit is a multi-subframe/subframe/multi-slot/slot/symbol/symbol group/DU F resource type for each slot.

In the present embodiment, radio resources are controlled by an appropriate method, which will be described in detail below. That is, in order to prevent interference in FDM, in the present embodiment, diligent efforts have been made for the IAB node to be able to accurately determine the availability and the like of the DU resource such that in the DU serving cells, an appropriate guard band is configured between the MT resource and the DU resource in the frequency direction.

### (2) Function Block Configuration of Radio Communication System

Next, a function block configuration of the parent node 100A and the IAB node 100B included in the radio communication system 10 will be described. In addition, the child node 100C may have the same configuration as that of the IAB node 100B, which will not be described herein to avoid an overlapping description.

### (2.1) Parent Node 100A

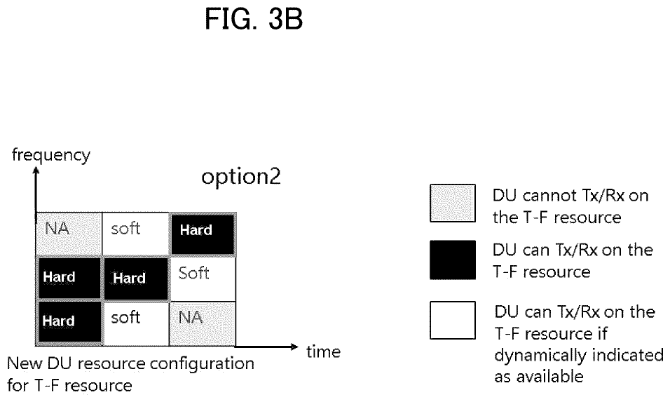

FIG. 4 is a configuration diagram illustrating a functional block of the parent node 100A. As illustrated in FIG. 4, the parent node 100A includes a radio transmission unit 110, a radio reception unit 120, an NW IF unit 130, an IAB node connection unit 140, and a control unit 150.

The radio transmission unit 110 transmits radio signals according to the 5G or 6G specification. The radio reception unit 120 also transmits radio signals according to the 5G or 6G specification. In the present embodiment, the radio transmission unit 110 and the radio reception unit 120 perform radio communication with the IAB node 100B.

In the present embodiment, the parent node 100A has MT and DU functions, and the radio transmission unit 110 and the radio reception unit 120 also transmit and receive radio signals corresponding to MT/DU.

In the present embodiment, the radio transmission unit 110 can transmit configuration information or the like regarding the availability of radio resources for parent nodes and/or for lower nodes in the IAB node 100B, to the IAB node 100B. More specifically, the radio transmission unit 110 can transmit configuration information or the like regarding the availability of radio resources on the MT side/DU side in the IAB node 100B, to the IAB node 100B. Specific examples of the configuration information may be information (H/S/NA) which includes “hard (H)” indicating that a radio resource is used exclusively for a lower node (DU), “soft(S)” indicating that a radio resource is not designated exclusively for a lower node, or “NA (not available)” indicating that a radio resource is not available for a lower node.

Further, the configuration information may be information indicating that a radio resource is available or not available for a lower node, which may be designated when a radio resource is not designated exclusively for a lower node (soft(S)). For example, the configuration information may be information referred to as a dynamic indication or an availability indicator (AI). Furthermore, the above information may also include information (UL/DL/F) that further specifies uplink (UL), downlink (DL), or Flexible that is available for either DL or UL, in communication for a lower node (DU) in the IAB node 100B. Note that the configuration information includes not only the information explicitly indicated, but also the information implicitly indicated. Specifically, when there is no explicit indication from the network, the CU 50, or a parent node for a certain period of time for a radio resource configured as soft, this fact may be interpreted as an implicit indication, and control may be performed such that the radio resource is used for a lower node, on the basis of the configuration information, for example.

The NW IF unit 130 provides a communication interface for realizing connection with the NGC side such as the CU 50. For example, the NW IF unit 130 may include interfaces such as X2, Xn, N2, and N3.

The IAB node connection unit 140 provides an interface or the like that realizes connection with the IAB node (or may be a child node including the UE). Specifically, the IAB node connection unit 140 provides a distributed unit (DU) function. That is, the IAB node connection unit 140 is used for connection with the IAB node (or child node).

Note that the IAB node may be described as a RAN node that supports radio access to the UE 200 and backhauls access traffic by using radio. In addition, the parent node or the IAB donor may be described as a RAN node that provides an UE interface to the core network and provides a radio backhaul function to the IAB node.

The control unit 150 controls each functional block included in the parent node 100A. For example, the control unit 150 may perform control over the DU soft resource of the IAB node 100B via the transmission of configuration information such as a dynamic indication and an availability indicator (AI). The control unit 150 may perform an implicit indication by not transmitting the configuration information. For example, the configuration information indicating that the DU resource is soft is transmitted from the CU 50 to the IAB node 100B. In this regard, the control unit 150 may perform an implicit indication by causing the parent node 100A, which belongs to the MCG or the like, to not transmit the explicit configuration information about the DU soft resource. That is, the fact that there is no explicit indication from the network about the radio resource available in both a DU and MT can be configuration information indicating an implicit indication.

The control unit 150 may have a semi-static configuration that indicates whether the DU soft resource of the IAB node is available in any of DL/UL/F. This semi-static configuration may mean that the configuration is not changed dynamically but may be updated or changed on the basis of an indication from the network.

The control unit 150 may acquire the resource configuration information of the child node (IAB node 100B) that is received from CU 50 via the NW IF unit 130. For example, the control unit 150 may acquire the configuration information (for example, the H/S/NA type of the DU resource of the child node) relating to the resource configuration of the child node (that is, the IAB node 100B) seen from the control unit 150. Thus, for example, when the received configuration information of the target DU resource of the child node is soft, the control unit 150 can dynamically control the DU soft resource.

### (2.2) IAB Node 100B

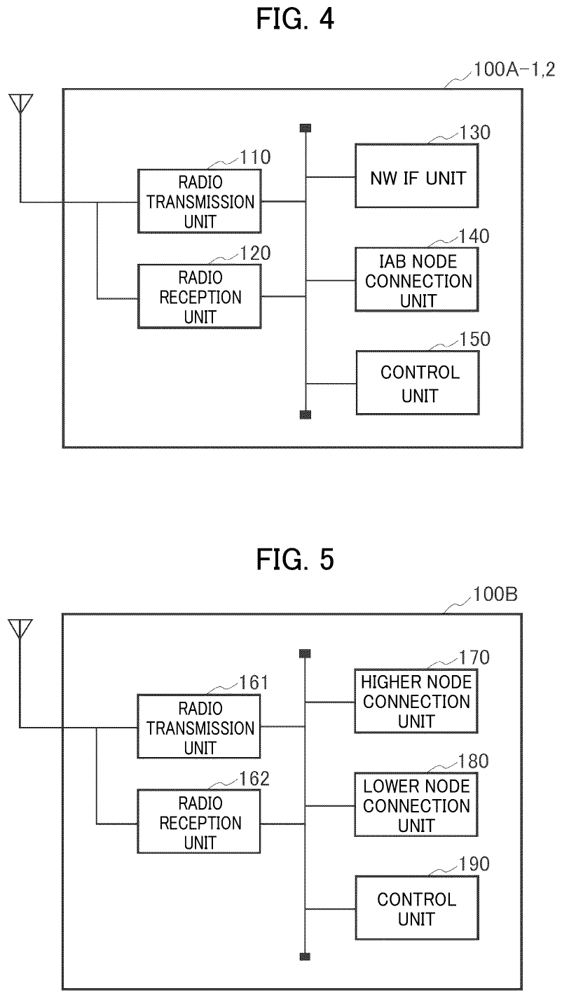

FIG. 5 is a configuration diagram illustrating a functional block of the IAB node 100B constituting an IAB node. As illustrated in FIG. 5, the IAB node 100B includes a radio transmission unit 161, a radio reception unit 162, a higher node connection unit 170, a lower node connection unit 180, and a control unit 190.

Thus, the IAB node 100B has a function block similar to that of the parent node 100A described above, but differs in that the IAB node 100B includes the higher node connection unit 170 and the lower node connection unit 180, and also differs in the function of the control unit 190.

The radio transmission unit 161 transmits radio signals according to the 5G or 6G specification. The radio reception unit 162 receives radio signals according to the 5G or 6G specification. In the present embodiment, the radio transmission unit 161 and the radio reception unit 162 perform radio communication with higher nodes such as the parent nodes 100A and radio communication with lower nodes such as the child nodes (including the UE 200). For example, the radio reception unit 162 receives configuration information or the like regarding a radio resource (DU resource) for at least lower nodes, from the network such as the parent node 100A. For example, the radio reception unit 162 may receive configuration information or the like regarding the availability of a frequency resource for parent nodes and/or for lower nodes in the IAB node 100B.

The higher node connection unit 170 provides an interface and the like for realizing connection with higher nodes than the IAB node. A higher node may be a radio communication node located on the network, more specifically, on the core network side (which may be referred to as the upstream or uplink side) from the IAB node. Specifically, the higher node connection unit 170 provides a mobile termination (MT) function. That is, in the present embodiment, the higher node connection unit 170 is used for connection with a parent node 100A constituting a higher node.

The higher node connection unit 170 is not limited to radio communication, and may be connected to the core network such as the CU 50 via a wired transmission line or the like. As a result, the control unit 190 can receive configuration information regarding radio resources for at least lower nodes from the CU 50 via the higher node connection unit 170. For example, the control unit 190 may receive configuration information regarding the availability of radio resources for parent nodes and/or for lower nodes in the IAB node 100B, from the CU 50 via the higher node connection unit 170. However, the present embodiment is not limited thereto. For example, the radio reception unit 120 may acquire configuration information or the like from the CU 50 by means of radio communication.

The lower node connection unit 180 provides an interface and the like for realizing connection with lower nodes than the IAB node. The lower node refers to a radio communication node that is located on the end-user side (which may be referred to as the downstream or downlink side) from the IAB node.

Specifically, the lower node connection unit 180 provides a distributed unit (DU) function. That is, the lower node connection unit 180 is used for connection with the child nodes (which may be the UE 200) including the lower nodes in the present embodiment.

In the present embodiment, the higher node connection unit 170 is used for connection with the parent node 100A, and the lower node connection unit 180 is used for connection with the lower nodes (such as the child node 100C). Further, the higher node connection (MT connection) and lower node connection (DU connection) can share a radio resource.

The control unit 190 controls each functional block constituting the IAB node 100B. In particular, in the present embodiment, the control unit 190 performs control regarding radio resources.

As described above, the radio resources in the IAB node 100B can be used for both an MT and DU. Further, an MT can be connected to the parent node 100A. For this reason, the control unit 190 controls the radio resources that can be shared by parent nodes and lower nodes.

More specifically, the control unit 190 controls the radio resources for parent nodes (MT side) and/or for lower nodes (DU side) on the basis of the configuration information received from the CU 50 or the parent node 100A. In particular, in the present embodiment, the control unit 190 controls a guard band. Here, the control unit 190 may determine a guard band on the basis of the configuration information or the like explicitly indicated from the network (including the parent nodes, CU, or the like), or on the basis of the implicit information or the like suggested from the configuration information, a usage state, or the like. Specific examples of implicit or explicit guard band determination methods will be described later.

The channels include control channels and data channels. The control channels include a PDCCH (physical downlink control channel), a PUCCH (physical uplink control channel), a PRACH (physical random access channel), and a PBCH (physical broadcast channel).

The data channels include a PDSCH (physical downlink shared channel), and a PUSCH (physical uplink shared channel).

The reference signals include demodulation reference signals (DMRS), sounding reference signals (SRS), phase tracking reference signals (PTRS), and channel state information-reference signals (CSI-RS), and the signals include the channels and the reference signals. Further, the data may mean the data transmitted via the data channels.

UCI is control information that is symmetric to downlink control information (DCI), and UCI is transmitted via a PUCCH or a PUSCH. UCI may include a scheduling request (SR), a hybrid automatic repeat request (HARQ) ACK/NACK, and a channel quality indicator (CQI).

The control unit 190 may control the radio resource including the configuration of the guard band on the basis of the availability of the radio resource indicated by the configuration information. Specifically, the control unit 190 can determine the availability of the DU resource on the basis of the H/S/NA information indicated by the configuration information as well as configuration information of IA (indicated as available) or INA (indicated as not available) when the target resource is soft(S). “IA” means that the DU resource is explicitly or implicitly indicated as available. Also, “INA” means that the DU resource is explicitly or implicitly indicated as unavailable. As the configuration information, the control unit 190 may control the DU resource (frequency resource and/or time resource) on the basis of the configuration information such as an availability indicator (AI) in addition to a dynamic indication. For example, when the radio resource is not designated exclusively for the lower nodes, such as when the target resource is soft(S), the control unit 190 may receive, from the CU 50 or one of the multiple parent nodes 100A-1 and 2, the configuration information (for example, dynamic indication or the like) regarding the availability of the radio resource for lower nodes, and control the radio resource for parent nodes (MT side) and/or for lower nodes (DU side) on the basis of the received configuration information.

Further, the control unit 190 may grasp the usage state of the radio resources for parent nodes (MT side) via the higher node connection unit 170, and may grasp the usage state of the radio resources for lower nodes (DU side) via the lower node connection unit 180. In addition, the control unit 190 may control the radio resources on the basis of the usage state of the radio resources for parent nodes and/or for lower nodes in addition to the configuration information.

When multiple pieces of configuration information are received as in option 1, the control unit 190 may control the radio resource as below. That is, for example, when the radio resource is designated exclusively for lower nodes (hard) in all pieces of configuration information, the control unit 190 may control the radio resource to be used for lower nodes. In addition, when the radio resources is indicated as not available for lower nodes in at least one piece of the configuration information, the control unit 190 may control the radio resource so as not to be used for lower nodes.

In addition, when multiple pieces of configuration information are received and when the configuration information received from the parent node indicates that the radio resource is available for lower nodes, the control unit 190 may control radio resources so as to be used for lower nodes. In addition, when multiple pieces of configuration information are received and radio resources are not used for higher nodes, the control unit 190 may also control the radio resources so as to be used for lower nodes.

As described above, even when multiple pieces of configuration information are received from the network, the control unit 190 can appropriately perform allocation control for MT/DU radio resources. Note that some or all of the above conditions may be implemented in any combination.

### (3) Operation of Radio Communication System

Next, an operation of the radio communication system 10 will be described. Specifically, when simultaneous operation of MT/DU is realized using FDM, the operation for controlling a radio resource including the configuration of a guard band in the IAB node will be described.

### (3.0) Schematic Operation

As described above, when realizing simultaneous operation of MT/DU in FDM (transmission and reception such as MT Tx/DU Tx (MT transmission/DU transmission), MT Tx/DU Rx (MT transmission/DU reception), MT Rx/DU Tx (MT reception/DU transmission), and MT Rx/DU Rx (MT reception/DU reception)), interference is likely to occur. Therefore, it is necessary to control radio resources by using an appropriate method including the configuration of a guard band. For this reason, various control methods for radio resources including the configuration of a guard band will be described below.

(3.1) Operation Example 1: An Example in which a Guard Band is Implicitly Configured

First, Operation example 1 where a guard band is implicitly configured will be described. Specifically, the following cases and options will be described. The method of each case and the method of each option described below may be performed in any combination.
Case 1: Guard band between DU H/NA resources
Case 2: Guard band between DU H/S-INA resources
Case 3: Guard band between DU S-IA/NA resources
Case 4: Guard band between DU S-IA/S INA resources
Option 0: IAB node assumes that an IAB DU resource and an IAB MT resource are not adjacent to each other.
Option 1: “x” Subcarrier/RBs/RBGs of an IAB MT resource which is adjacent to an IAB DU resource is treated as a guard band.
Option 2: “x” Subcarrier/RBs/RBGs of an IAB DU resource which is adjacent to an IAB MT resource is treated as a guard band.
   Option x-1: Only if DU and MT transmit and receive simultaneously
   Option x-2: Always
   Simultaneous support for Option 1/2 is also assumed

Options regarding how to determine a guard band “x” are as follows:
Option 1: Report from IAB node to parent node
Option 2: Report from IAB node to IAB donor CU
Option 3: Report as capability of IAB node (capability information)
Option 4: Parent node notifies IAB node or performs configuration with respect to IAB node
Option 5: IAB donor CU notifies IAB node or performs configuration with respect to IAB node
Option 6: Specify fixed value
Option 7: Depend on implementation of IAB node DU
Option 7-1: Don't specify in specification
Option 7-2: Specify operation of IAB node
Option 8: Depend on implementation of parent node
Option 8-1: Don't specify in specification
Option 8-2: Specify operation of IAB node

A description will be given in detail below regarding each case of Operation example 1 and an example of each option. As described below, regarding a frequency resource determined as a guard band, a DU cannot perform transmission and reception (Tx/Rx) and an MT cannot perform transmission and reception (Tx/Rx), or an IAB node does not assume that simultaneous communication with MT transmission and reception (Tx/Rx) is configured/indicated. In the following description, “X” is the size of a guard band.

### (3.1-1) Operation Example 1-1: Case 1

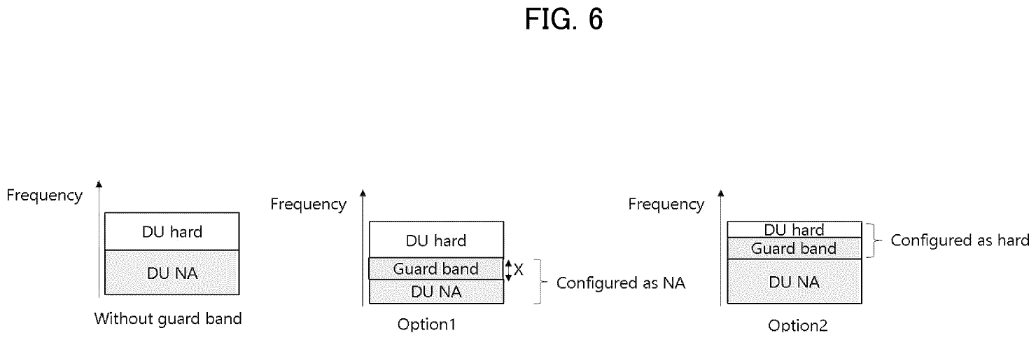

Case 1 (a guard band at a boundary between H/NA frequency resources in adjacent DUs) will be described. FIG. 6 illustrates an example of Case 1 (a guard band at a boundary between H/NA frequency resources in adjacent DUs). In Case 1, the following options may be employed.

In option 0, the IAB node does not assume that the frequency resources of DU hard and DU NA are configured to be adjacent at the subcarrier/RB/RBG level.

As illustrated in FIG. 6, in option 1, the X subcarrier/RB/RBG in the NA resource adjacent to the hard resource is used as a “guard band”. In this case, the MT cannot perform transmission and reception (Tx/Rx) or the IAB node does not assume that the MT transmission/reception (Tx/Rx) is configured/specified, on the NA frequency resource determined as a guard band on a symbol/slot. The following options may be employed.

Option 1-1: Applicable only if there is DU simultaneous transmission/reception (Tx/Rx) on the adjacent hard frequency resource on the symbol/slot (subcarrier/RB/RBG).

Option 1-2: Always applicable with or without simultaneous operation.

As illustrated in FIG. 6, in option 2, the X subcarrier/RB/RBG in the hard resource adjacent to the NA resource is used as a “guard band”. In this case, the DU cannot perform transmission/reception (Tx/Rx) on the resource determined as a guard band even when the resource is configured as hard. The following options may be employed.

Option 2-1: Applicable only if there is MT simultaneous transmission/reception (Tx/Rx) on the adjacent NA frequency resource on the symbol/slot (subcarrier/RB/RBG).

Option 2-: Always applicable.

### (3.1-2) Operation Example 1-2: Case 2

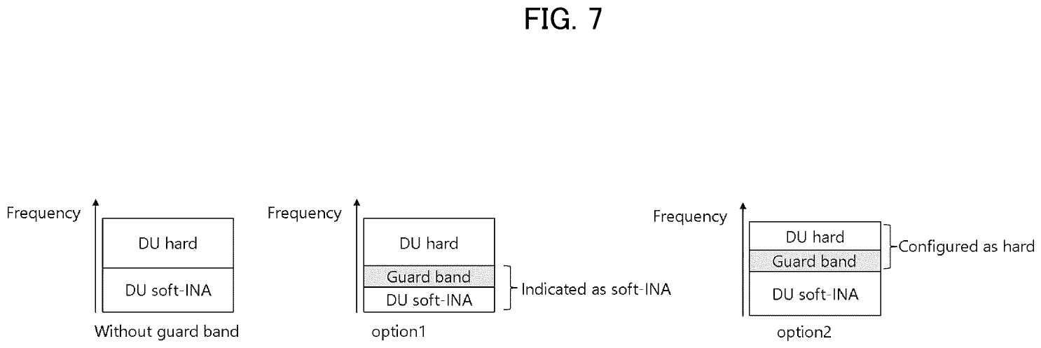

Case 2 (a guard band at a boundary between hard/soft INA resources) will be described. FIG. 7 is a diagram illustrating an example of Case 2 (a guard band at a boundary between hard/soft INA resources).

In option 0, the IAB node does not assume that the hard and soft INA resources are configured to be adjacent at the subcarrier/RB/RBG level. For example, the IAB node does not assume that the X subcarrier/RB/RBG in the soft resource adjacent to the hard resource is configured as “INA.” Alternatively, the X subcarrier RB/RB in the soft resource adjacent to the hard resource is always configured as “IA”.

As illustrated in FIG. 7, in option 1, the X subcarrier/RB/RBG in the soft INA resource adjacent to the hard resource is used as a “guard band”. In this case, the MT cannot perform transmission and reception (Tx/Rx) or the IAB node does not assume that MT transmission/reception (Tx/Rx) is configured/indicated, on the soft INA frequency resource determined as a guard band on a symbol/slot. The following options may be employed in this operation.

Option 1-1: Applicable only if there is DU simultaneous transmission/reception (Tx/Rx) on the adjacent hard frequency resource on the symbol/slot (subcarrier/RB/RBG).

Option 1-2: Always applicable.

As illustrated in FIG. 7, in option 2, the X subcarrier/RB/RBG in the hard resource adjacent to the soft INA resource is used as a “guard band”. In this case, the DU cannot perform transmission/reception (Tx/Rx) on the resource determined as a guard band even when the resource is configured as hard. The following options may be employed.

Option 2-1: Applicable only if there is MT simultaneous transmission/reception (Tx/Rx) on the adjacent soft frequency resource on the symbol/slot (subcarrier/RB/RBG).

Option 2-2: Always applicable.

As another embodiment (modified example) of Case 2, “soft-INA” may be read as meaning “soft” based on the above description.

### (3.1-3) Operation Example 1-3: Case 3

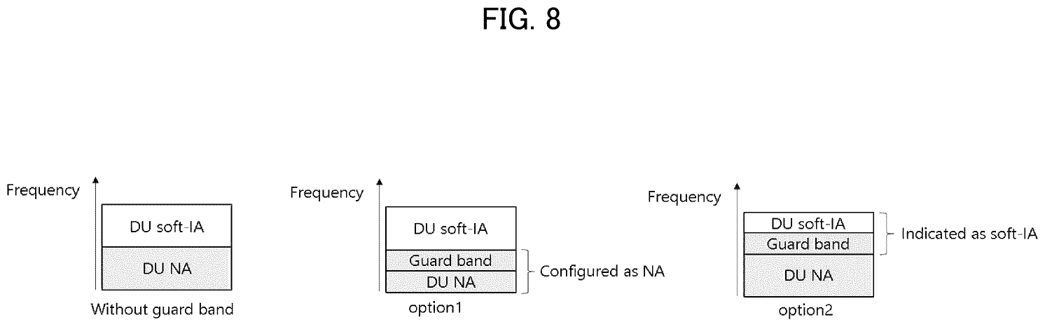

An operation of Case 3 (a guard band at a boundary between soft IA/NA resources) will be described. FIG. 8 is a diagram illustrating an example of Case 3 (a guard band at a boundary between soft IA/NA resources).

In option 0, the IAB node does not assume that the NA and soft IA resources are configured to be adjacent at the subcarrier/RB/RBG level. For example, the IAB node does not assume that the X subcarrier/RB/RBG in the soft resource adjacent to the NA resource is configured as “IA”. Alternatively, the IAB node expects the X subcarrier RB/RBG in the soft resource adjacent to the NA resource to be always configured as “INA”.

As illustrated in FIG. 8, as option 1, the X subcarrier/RB/RBG in the NA resource adjacent to the hard resource is used as a “guard band”. In this case, the MT cannot configure Tx/Rx or the IAB node does not assume that the MT transmission/reception (Tx/Rx) is configured/indicated at the NA frequency, on the resource determined as a guard band on a symbol/slot. The following operation options may be employed.

Option 1-1: Applicable only if there is DU simultaneous transmission/reception (Tx/Rx) on the adjacent soft IA frequency resource on the symbol/slot (subcarrier/RB/RBG).

Option 1-2: Always applicable.

As illustrated in FIG. 8, in option 2, the X subcarrier/RB/RBG in the soft IA resource adjacent to the NA resource is used as a “guard band”. In this case, the DU cannot perform transmission/reception (Tx/Rx) on the resource determined as a guard band even when the resource is indicated as a soft IA. The following options may be employed.

Option 2-1: Applicable only if there is MT simultaneous transmission/reception (Tx/Rx) on the adjacent NA frequency resource on the symbol/slot (subcarrier/RB/RBG).

Option 2-2: Always applicable.

As another embodiment (modified example) of Case 3, “soft-IA” may be replaced with “soft” based on the above description.

### (3.1-4) Operation Example 1-4: Case 4

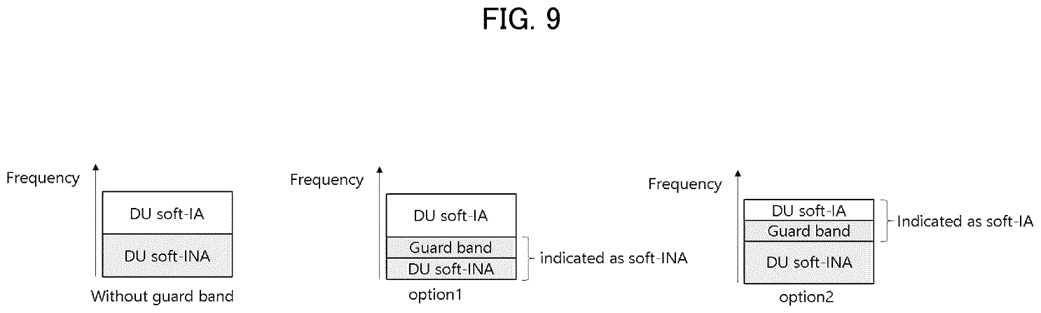

Case 4 (a guard band at a boundary between soft-IA/soft-INA resources) will be described. FIG. 9 is a diagram illustrating an example of Case 4 (a guard band at a boundary between soft-IA/soft-INA resources).

As illustrated in FIG. 9, in option 1, the X subcarrier/RB/RBG in the soft INA resource adjacent to the soft IA resource is used as a “guard band”. In this case, the MT cannot perform transmission/reception (Tx/Rx) or the IAB node does not assume that the MT transmission/reception (Tx/Rx) is configured/indicated, on the soft INA frequency resource determined as a guard band on the symbol/slot. The following options may be employed.

Option 1-1: Applicable only if there is DU simultaneous transmission/reception (Tx/Rx) on the adjacent soft IA frequency resource on the symbol/slot (subcarrier/RB/RBG).

Option 1-2: Always applicable.

As illustrated in FIG. 9, in option 2, the X subcarrier/RB/RBG in the soft IA resource adjacent to the soft INA resource is used as a “guard band”. In this case, the DU cannot perform transmission/reception (Tx/Rx) on the resource determined as a guard band even when the resource is indicated as a soft IA. The following options may be employed.

Option 2-1 Applicable only if there is MT simultaneous transmission/reception (Tx/Rx) on the adjacent INA frequency resource on the symbol/slot (subcarrier/RB/RBG).

Option 2-2 Always applicable.

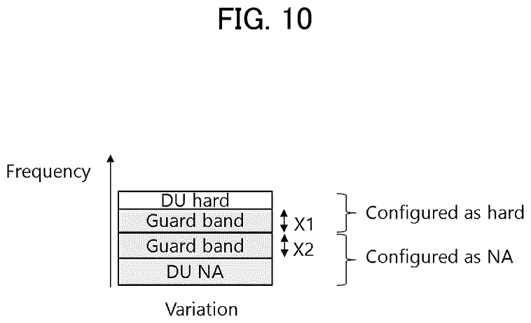

Here, FIG. 10 is a diagram illustrating another embodiment of Cases 1, 2, 3 and 4 (modified example). As illustrated in FIG. 10, both option 1 and option 2 may be supported. In this case, the above-described X may be read as meaning X1 and X2. In addition, X1 and X2 may be X/2, or [X/2] or [X/2].

### (3.1-5) Size of Guard Band X

The following options may be employed to determine the size of a guard band.
Option 1: Report from IAB node to parent node
Option 2: Report from IAB node to IAB donor CU
Option 3: Report as function of IAB node
Option 4: Configuration/indication from parent node to IAB node (In this case, the IAB node can report a desired size of a guard band to the parent node.)
Option 5: Configuration/indication from IAB donor CU to IAB node (In this case, a guard band of the IAB node also needs to be notified to the parent node. Note that the IAB node can report a guard band of a desired size to the IAB donor CU.)
Option 6: Predefined and/or fixed value
Option 7: By DU implementation of IAB node
   Option 7-1: No influence on additional specifications
   Option 7-2: An operation of the IAB node is specified. As for hard/soft/IA DU frequency resources (similar to the definition of an implicit determination on soft resource availability of Release 16), a DU can perform only transmission and reception (Tx/Rx) on frequency resources only when not affecting simultaneous MT transmission and reception (Tx/Rx) on adjacent DU soft INA/NA frequency resources. Alternatively, simultaneous MT transmission and reception (Tx/Rx) on adjacent DU soft INA/NA frequency resources is not changed by the DU transmission and reception (Tx/Rx). Otherwise, the DU cannot perform transmission and reception (Tx/Rx) at these frequencies (that is, on the guard bands).
Option 8: By implementation of parent node in configuration/indication of MT transmission/reception (Tx/Rx)
   Option 8-1: No influence on additional specifications
   Option 8-2: An operation of the IAB node is specified. As for NA/soft-INA DU frequency resources (similar to the definition of an implicit determination of soft resource availability of Release 16), a MT can perform only transmission and reception (Tx/Rx) on frequency resources (the IAB node assumes the configuration/indication of MT Tx/Rx) only when not affecting simultaneous DU transmission and reception (Tx/Rx) on adjacent DU hard/soft IA frequency resources. Alternatively, the MT can perform only transmission and reception (Tx/Rx) only when there is simultaneous DU transmission and reception (Tx/Rx) at adjacent DU hard/soft IA frequencies. Note that the resource is not changed for the MT transmission and reception (Tx/Rx). Otherwise, the MT cannot perform transmission and reception (Tx/Rx) (the IAB node does not assume the configuration/indication of MT Tx/Rx) on these frequency resources (that is, on the guard bands).

One or more of the above options may be supported. In addition, the above options may be transmitted or received via RRC/MAC CE/layer 1 signaling (UCI) when reported. In addition, the configuration/indication of the above options may be transmitted/received via RRC/MAC CE/layer 1 signaling (DCI). In addition, in the report/indication/configuration of the above options, the guard-band unit (granularity) may be subcarrier/N subcarrier (subcarrier group)/RB/N RB (RB group). In addition, the size of a guard band may be reported/indicated/configured as the number of subcarriers/subcarrier groups/RB/RB groups. As another embodiment (modified example), different guard bands may be reported/indicated/configured for different combinations of MT-Tx/Rx and DU-Tx/Rx.

(3.2) Operation Example 2: An Example in which a Guard Band is Explicitly Configured

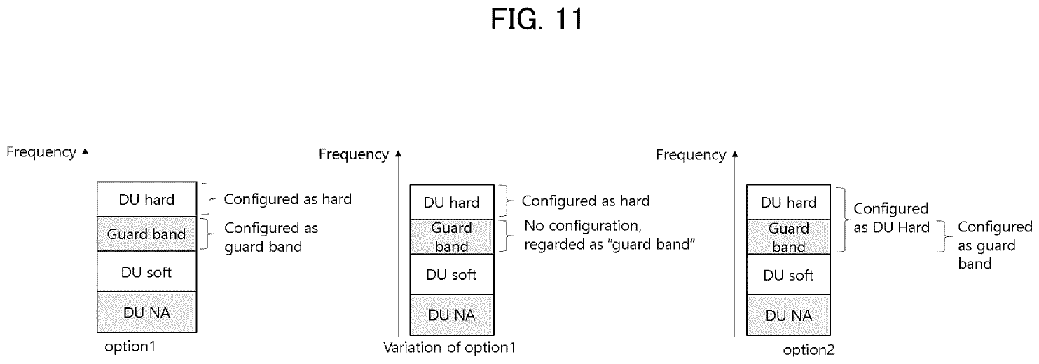

Next, Operation example 2 in which a guard-band is explicitly configured will be described. In this example, a guard-band pattern is explicitly configured. FIG. 11 is a diagram illustrating Operation example 2 in which a guard band is explicitly configured.

Here, the configuration/indication can be transmitted from an IAB donor CU/parent node via RRC/MAC CE/DCI. When formed by the IAB donor CU, a guard-band pattern of the IAB node is also notified to the parent node. The following options may be employed. Option 1: The guard band is configured with the same signaling as the configuration of the hard/soft/NA type of DU frequency resource (see the example of the semi-static resource configuration in FDM in IAB described above in FIG. 3). In addition to or without a hard/soft/NA type of DU frequency resource, it may be reused as a “resource type” that is considered to be a “guard band”. As a modified example, a frequency resource for which a hard/soft/NA type of resource is not configured may be considered to be a “guard band”.

In option 2, a guard band is configured/indicated with signaling that is independent of the configuration of a hard/soft/NA type of DU frequency resource. For example, the guard band can be configured/indicated as follows:

Option 2-1: A number of consecutive subcarrier/RB/RBGs are configured/indicated. The starting subcarriers/subcarrier groups/RBs/RB groups and the number of consecutive subcarriers/subcarrier groups/RBs/RB groups are configured/indicated.

Option 2-2: The bitmap corresponding to the subcarrier/subcarrier group/RB/RB group in the DU transmission bandwidth is configured/indicated. The DU cannot perform transmission and reception (Tx/Rx) on the frequency resource configured as a “guard band”. The MT cannot perform transmission and reception (Tx/Rx), or the IAB node does not assume the configuration/indication caused by MT transmission and reception (Tx/Rx).

In the present embodiment, “soft IA” may refer to being explicitly indicated as being available or being implicitly indicated as being available. Further, “soft-INA” may refer to being explicitly indicated as being unavailable, being implicitly indicated as being unavailable, and/or may have no explicit indication.

As another embodiment (modified example), the configuration/indication/report of a guard band may be performed per DU cell, per MT serving cell, and per pair of {DU cell and MT serving cell}.

In addition, as another embodiment (modified example), a guard band may be required for one or more or all of the following MT Tx/Rx and DU Tx/Rx combinations. Note that in the following combinations, the size of a guard band is different. This example is applied only to the combination in which a guard band is required.
MT Tx/DU Tx (MT Tx/DU Tx)
MT Tx/DU Rx (MT Tx/DU Rx)
MT Rx/DU Tx (MT Rx/DU Tx)
MT Rx/DU Rx (MT Rx/DU Rx)

As another embodiment (modified example), this example can be applied to simultaneous operation of an MT and DU between carriers, that is, applied to MT Tx/Rx and DU Tx/Rx on MT serving cells and to DU cells having no overlapping frequency bands. This example can be reused on the frequency resource of MT serving cells considered to be a “DU NA” resource type, and on the frequency resource of DU cells considered to be a “DU hard” resource type.

In addition, as another embodiment (modified example), the maximum number of guard bands (e.g., M) in a slot/N slots/a symbol/N symbols can be fixed and/or predefined and/or defined and reported as the function of an IAB node and/or configured by higher layer signaling. That is, the IAB node does not assume the number of guard bands that is more than M, in a slot/N slots/a symbol/N symbols.

In addition, as another embodiment (modified example), the maximum number per DU cell may be provided, the maximum number per MT serving cell may be provided, and the maximum number per pair of {DU cell and MT serving cell} may be provided.

In addition, as another embodiment (modified example), the maximum number of subcarriers/RBs/RBGs and the maximum number of guard bands (e.g., M) in a slot/N slots/a symbol/N symbols, which are configured/indicated/determined, can be fixed and predefined, and/or defined and/or reported as the capacity of an IAB node, and/or configured by higher layer signaling. That is, the IAB node assumes that the number of subcarriers/RBs/RBGs, which is configured/indicated/determined as guard bands in a slot/N slots/a symbol/N symbols, is less than or equal to M.

In addition, as another embodiment (modified example), the maximum number per DU cell may be provided, the maximum number per MT serving cell may be provided, and the maximum number per pair of {DU cell, MT serving cell} may be provided.

In addition, IAB node function and/or higher layer configuration described below can be defined.
Whether FDM is supported.
Whether FDM is supported for each of the following MT Tx/Rx and DU Tx/Rx combinations
MT Tx/DU Tx (MT Tx/DU Tx)
MT Tx/DU Rx (MT Tx/DU Rx)
MT Rx/DU Tx (MT Rx/DU Tx)
MT Rx/DU Rx (MT Rx/DU Rx).
Whether a guard band is required, and whether the size of a guard band is required.
The presence or absence of a guard band and the size of a guard band required for each of the following MT Tx/RX and DU Tx/Rx combinations
MT Tx/DU Tx (MT Tx/DU Tx)
MT Tx/DU Rx (MT Tx/DU Rx)
MT Rx/DU Tx (MT Rx/DU Tx)
MT Rx/DU Rx (MT Rx/DU Rx)

Note that a guard band is required in some of the above combinations such as MT Tx/DU Tx, and thus a function is not required for such combinations.
Whether a guard band is required.
The size of a guard band required at the boundary between the following combinations of DU frequency resources
Hard/NA
Soft IA (Soft)/NA
Soft INA (Soft) Hard
Soft IA/Soft INA

Note that a guard band may not be required for some of the above combinations, and thus no capability is required for such combinations.
The maximum number of guard bands configured/indicated/determined in a slot/N slots/a symbol/N symbols
The maximum number of subcarriers/RBs/RBGs configured/indicated/determined as guard bands in a slot/N slots/a symbol/N symbols

As another embodiment (modified example), the above functions can be performed per DU cell, per MT serving cell, and per pair of {DU cell, MT serving cell}. In addition, the above embodiment is applied only if the corresponding IAB node capability is supported and/or configured by the corresponding higher layer parameter.

The operation examples of the present embodiment have been described as above.

### (4) Action and Effect

According to the above embodiments, the following action and effect can be obtained. Specifically, the IAB node 100B or the base station according to the present embodiment includes: a connection unit (higher node connection unit 170 and lower node connection unit 180) that is used for connection for a parent node (parent node 100A) and for a lower node (child node 100C) that are capable of sharing a radio resource in frequency division multiplexing; and a control unit (control unit 190) that controls a guard band relating to the radio resource for the parent node (parent node 100A) and for the lower node (child node 100C).

According to the present embodiment, when frequency division multiplexing (FDM) is performed in an MT and DU in integrated access and backhaul (IAB), a guard band can be properly configured on a frequency resource, thereby preventing interference.

In addition, according to the present embodiment, the control unit 190 configures the guard band based on a state relating to the radio resource (DU H/S/NA or semi-static resource configuration).

Accordingly, the present embodiment makes it possible to configure the guard band appropriately by determining the state (that is, by reading an implicit suggestion), even when there is no explicit configuration or indication from the network.

Further, the control unit 190 controls the guard band based on the configuration information received from the central unit 50 or the parent node 100A or the network.

This makes it possible to control appropriate resources in an MT and DU including the configuration of a guard band, by acquiring a configuration/indication/notification of the availability of the resources that can be shared (that is, by explicit instructions).

### (5) Other Embodiments

The embodiments have been described as above; however, the present disclosure is not limited to the description of the embodiments, and it will be obvious to those skilled in the art that various modifications and improvements are possible.

For example, a radio resource for a parent node (MT side) and/or for a lower node (DU side) may be controlled on the basis of the usage state of the radio resource for the parent node, in addition to the received configuration information. For example, even when there is no explicit indication from the higher node about DU soft resources, resources can be appropriately controlled by considering the usage status of radio resources on the MT side that can be shared. More specifically, resources can be controlled such that when a target resource is used on the MT side, the resource is not used as DU resource, and such that when a target resource is not used on the MT side, the resource is used as DU resource.

In addition, when a radio resource is not designated exclusively for a lower node (for example, hard) (for example, DU soft resource), configuration information (for example, dynamic indication such as available or NA (not available)) relating to the availability of the radio resource for the lower node is received from the central unit 50 or one of the multiple parent nodes 100A-1 and 2, and a radio resource for the parent node (MT side) and/or for the lower node (DU side) is controlled based on the received configuration information. Thus, even when a radio resource is not designated exclusively for the lower node (for example, DU soft resource), resources can be precisely controlled according to the availability of the target node that is indicated by the higher node.

In addition, when multiple pieces of configuration information are received and a radio resource is designated exclusively for a lower node (for example, hard) in all pieces of configuration information, the radio resource may be controlled so as to be used for the lower node. When multiple pieces of configuration information are received and when a radio resource is indicated as being unavailable for a lower node (for example, NA) in at least one of the multiple pieces of information, the radio resource is controlled so as not to be used for the lower node, and/or control is performed as to whether the radio resource is used for the lower node, on the basis of the configuration information that is received from the parent node in which a radio resource is not designated exclusively for the lower node (for example, hard), from among the multiple pieces of configuration information. Thus, resources can be precisely managed even when there are multiple pieces of configuration information.

In addition, according to the present embodiment, when multiple pieces of configuration information are received and at least one piece of the configuration information indicates that a radio resource is available for a lower node, and/or when the radio resource is not used for a higher node, the radio resource is controlled so as to be used for the lower node, and thus the resource can be precisely managed according to the multiple pieces of configuration information and/or the usage state of the resource in MT.

In the above-described embodiments, the names parent node, IAB node, and child node are used, but the names may be different as long as a radio communication node configuration is employed in which radio backhaul between a radio communication nodes such as a gNB and radio access with a terminal are integrated. For example, these may be simply referred to as a first and second nodes, or these may be referred to as a higher node and a lower node, or a relay node and an intermediate node.

In addition, the radio communication node may also be simply referred to as a communication device or a communication node, or may be read as a radio base station.

In the above-described embodiments, the terms downlink (DL) and uplink (UL) are used; however, the different terms may be used. For example, the above terms may be read as meaning or associated with terms such as a forward ring, a reverse link, an access link, and backhaul. Alternatively, terms such as a first link, a second link, a first direction, and a second direction may simply be used.

The block diagram (FIGS. 3, 4) used in the description of the above-described embodiment shows blocks in units of functions. Those functional blocks (components) can be realized by a desired combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work is called a transmitting unit or a transmitter. For any of the above, as described above, the realization method is not particularly limited.

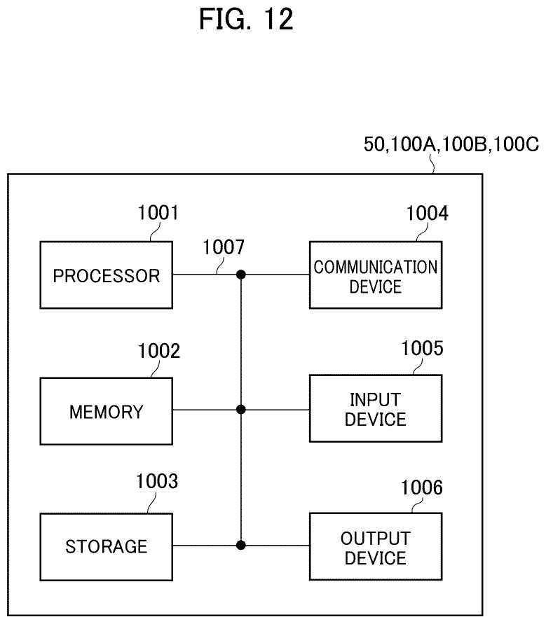

Further, the above-described CU 50, gNBs 100A to 100C, and UE 200 (the device) may function as a computer that performs processing of a radio communication method of the present disclosure. FIG. 12 is a diagram showing an example of a hardware configuration of the device. As shown in FIG. 12, the device may be configured as a computer device including a processor 1001, a memory 1002, a storage 1003, a communication device 1004, an input device 1005, an output device 1006, a bus 1007, and the like.

Furthermore, in the following description, the term “device” can be substituted with circuit, device, unit, or the like. The hardware configuration of the device may include one or more devices shown in the figure or may not include some of the devices.

Each of the functional blocks of the device (see FIGS. 3, 4) is implemented by means of any of hardware elements of the computer device or a combination of the hardware elements.

In addition, each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a Central Processing Unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above can be executed by one processor 1001 or can be executed simultaneously or sequentially by two or more processors 1001. The processor 1001 can be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 can be referred to as an auxiliary storage device. The recording medium can be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI)), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure can be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present invention may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or a desired combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure can be represented by an absolute value, can be represented by a relative value from a predetermined value, or can be represented by corresponding other information. For example, a radio resource can be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be substituted with a mobile station (user terminal, hereinafter the same). For example, each aspect/embodiment of the present disclosure may be applied to a configuration in which communication between a base station and a mobile station is replaced with communication between a plurality of mobile stations (for example, this may be called Device-to-Device (D2D), Vehicle-to-Everything (V2X), or the like). In this case, the mobile station may have the function of a base station. In addition, words such as “uplink” and “downlink” may also be substituted with words corresponding to inter-terminal communication (for example, “side”). For example, an uplink channel, a downlink channel, or the like may be substituted with a side channel.

Similarly, the mobile station in the present disclosure may be read as a base station. In this case, the base station may have the function of the mobile station. A radio frame may be composed of one or more frames in the time domain. Each of the one or more frames in the time domain may be referred to as a subframe. A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1-13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-encoded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as a TTI having a time length exceeding 1 ms, and a short TTI (for example, shortened TTI) may be read as a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a physical resource block (PRB), a sub-carrier group (SCG), a resource element group (REG), a PRB pair, a RB pair, and the like.

A resource block may be configured by one or more resource elements (REs). For example, one RE may be a radio resource domain of one subcarrier and one symbol.

A bandwidth part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be set in one carrier for the UE.

At least one of the configured BWPs may be active, and the UE does not have to expect to transmit and receive predetermined signals/channels outside the active BWP. Note that “cell”, “carrier”, and the like in this disclosure may be read as “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the cyclic prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be substituted with “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 Radio communication system
50 CU
100A Parent node
100B IAB node
100C Child node
110 Radio transmission unit
120 Radio reception unit
130 NW IF unit
140 IAB node connection unit
150 Control unit
161 Radio transmission unit
162 Radio reception unit
170 Higher node connection unit
180 Lower node connection unit
190 Control unit
200 UE
1001 Processor
1002 Memory
1003 Storage
1004 Communication device
1005 Input device
1006 Output device
1007 Bus

1. A radio communication node comprising:
a connection unit that is used for connection for a parent node and for a lower node that are capable of sharing a radio resource in frequency division multiplexing; and
a control unit that controls a guard band relating to the radio resource for the parent node and for the lower node.

2. The radio communication node according to claim 1, wherein
the control unit configures the guard band based on a state relating to the radio resource.

3. The radio communication node according to claim 1, wherein
the control unit receives configuration information relating to the guard band from the parent node or a central unit or a network.

4. A base station comprising:
a connection unit that is used for connection for a parent node and for a lower node that are capable of sharing a radio resource in frequency division multiplexing; and
a control unit that controls a guard band relating to the radio resource for the parent node and for the lower node.

5. A radio communication method comprising:
a step of performing connection for a parent node and for a lower node that are capable of sharing a radio resource in frequency division multiplexing; and
a step of controlling a guard band relating to the radio resource for the parent node and for the lower node.
